(19) United States
(12) Patent Application Publication
(10) Pub. No.: US 2013/0108901 A1
(43) Pub. Date: May 2, 2013

(54) BATTERY HOUSING FOR ACCOMMODATING ELECTROCHEMICAL ENERGY STORAGE CELLS

(71) Applicants: Tim Schaefer, Harztor (DE); Claus-Rupert Hohenthanner, Hanau (DE)

(72) Inventors: Tim Schaefer, Harztor (DE); Claus-Rupert Hohenthanner, Hanau (DE)

(73) Assignee: LI-TEC BATTERY GMBH, Kamenz (DE)

(21) Appl. No.: 13/636,120

(22) PCT Filed: Mar. 14, 2011
(86) PCT No.: PCT/EP11/01257

§ 371 Date: Jan. 8, 2013

(30) Foreign Application Priority Data
Mar. 19, 2010 (DE) 10 2010 011 983.0

(51) Int. Cl. H01M 2/10; H01M 10/50

(52) U.S. Cl. CPC H01M 2/1016; H01M 2/1022; H01M 2/1072; H01M 10/50
USPC 429/62; 429/82; 429/71; 29/623.1

(57) ABSTRACT

A battery housing comprises a cell compartment element (1) which at least partially delimits a cell compartment. Said cell compartment is designed to accommodate at least one electrochemical energy storage cell. A lid element (2) which is designed to be connected to the cell compartment element (1) obturates the cell compartment at least in sections thereof. The lid element (2) preferably comprises at least one fastening pin (29) and/or a bore (30) for a fastening pin for fastening the battery housing.

The present invention relates to a battery housing for accommodating a plurality of electrochemical energy storage cells and a method for manufacturing said battery housing.

A battery housing in terms of the invention substantially encloses at least two electrochemical energy storage cells within rigid walls. Such a battery housing preferably comprises a plurality of cell compartments, albeit at least one cell compartment, wherein one or more electrochemical energy storage cells is/are arranged in one cell compartment. The battery housing is provided for the purpose of keeping external loads such as e.g. applications of force away from the electrochemical energy storage cells and controlling the temperature balance.

Battery housings utilized up to this point control the temperature balance of energy storage cells by means of relatively complex spatial arrangements of same as in DE 10 2008 014 155 A1, for example. This type of arrangement can be achieved using at times complex housing elements as for example in DE 10 2007 063 269 A1. Complex housings are mechanical components which are not easily manufactured. One aspect of the present invention is therefore to provide an easily manufactured battery housing for electrochemical energy storage cells.

The invention is thus based on the task of providing a battery housing which serves to increase the operational reliability of electrochemical energy storage cells.

This task is achieved in accordance with the invention by the teaching of the independent claims. Preferred further developments of the invention constitute the subject matter of the subclaims.

A battery housing comprises at least one cell compartment element, preferably a plurality of cell compartment elements. A cell compartment element preferably at least partially delimits a cell compartment, particularly preferably is for two cell compartment elements to at least partially delimit one cell compartment. A cell compartment is preferably provided to accommodate one, preferably a plurality, and particularly preferably two electrochemical energy storage cells. A flexible compensating element is preferably provided between two electrochemical energy storage cells. The battery housing to accommodate electrochemical energy storage cells preferably comprises at least one and particularly preferably a plurality of cell compartments. A cell compartment element and a cover element, preferably a plurality of cell compartment elements and two cover elements, preferably delimit one, preferably a plurality of cell compartments. Preferably, one cover element and one cell compartment element can be connected together.

A cover element preferably comprises a securing bolt. A cover element preferably comprises a bore for a securing bolt.

An electrochemical energy storage cell comprises at least one electrode stack, one current conductor and one enclosure. An electrochemical energy storage cell is provided for the purpose of converting electrical energy into chemical energy and storing it. Conversely, the electrochemical energy storage cell can also convert the stored chemical energy back into electrical energy and release it. Such an electrochemical energy storage cell is preferably realized as a lithium-ion battery,

To be understood by a cell compartment element is a thin-walled shaped component which at least partially substantially delimits a cell compartment. A cell compartment is preferably a tubular body, at least in some areas, having a preferably rectangular cross section. Preferably, two cell compartment elements form one tubular body, preferably with a rectangular cross section at least in some areas. An at least partly tubular body preferably comprises two edge openings on its front faces. At least one section of the wall of a cell compartment element forms at least one section of the outer surface of the battery housing, preferably a side wall section of the battery housing. A temperature-conductive connection preferably exists between one cell compartment element and at least one electrochemical energy storage cell.

A side wall of the battery housing refers to the lateral delimitation of said battery housing. Said side wall sectionally delimits the contents of the battery housing from the environment surrounding the battery housing. Said side wall is in particular formed by one or more cell compartment elements.

To be understood by a cover element according to the invention is a component or a mechanism provided to close an edge opening. Depending on the design of the cell compartment elements, a cell compartment preferably exhibits one or preferably two edge openings; preferably two edge openings are closed by two cover elements. A cover element preferably comprises plastic as a component part. A cover element preferably at least partially delimits the contents of the battery housing from the environment surrounding the battery housing. A cover element preferably comprises a securing bolt. A cover element preferably comprises a bore for a securing bolt. Said bore for a securing bolt preferably comprises a screw thread. A cover element is particularly provided to selectively conduct a tempering medium flow to or from the cell compartment elements. A cover element preferably comprises hollow spaces for conducting the tempering medium. Said hollow spaces are particularly designed such that not only one flow of tempering medium can flow through the cell compartment elements but in particular two or more flows of tempering medium can flow through the cell compartment elements. By means of a predefined design to the hollow spaces, flows can preferably pass through the cell compartment elements in any given order. Said hollow spaces can preferably be designed such that the tempering medium flows through at least two or preferably all of the cell compartment elements in parallel. Mechanisms provided for the purpose of actively conducting the tempering medium flow can in particular be incorporated into a cover element.

Actively conducting the tempering medium flow refers to predefined hollow spaces of the cover element being opened or closed particularly as a function of external control commands or as a function of the temperature of the tempering medium. Thermostats or valves are particularly provided for conducting the flow of tempering medium.

A cover element preferably comprises one, preferably two to four or more, securing bolts and/or bores for each respective securing bolt. To be understood by such a securing bolt is a component which is positively or force-fit connected or materially bonded to the cover element. A securing bolt is particularly provided to transmit forces to the cover element, respectively to conduct them away from same. Such a securing bolt preferably serves to transmit force between the cover element and a base plate or other component. Such a securing bolt preferably serves in securely connecting or fixing the cover element to a base plate or other component. A bore for a securing bolt arranged on the cover element alternatively serves the same purpose. In this case, the associated securing bolt is fixed to a base plate or other component. Such a bore thereby receives at least sections of the associated securing bolt. The securing bore preferably has a screw thread for receiving the securing bolt. The battery housing is preferably securely fixed and its operational reliability thus increased by the particularly secure fixing of the cover element by means of a securing bolt or by means of a bore for a securing bolt.

To be understood by a partition wall is a wall extending within the interior of the battery housing which can comprise hollow spaces and/or recesses. Said wall preferably delimits at least sections of the cell compartment and is in particular a component of the cell compartment element.

A connecting element in the sense of the invention refers to a component provided to create a positive connection between a cover element and at least one cell compartment element.

In accordance with the invention, a snap-lock connection is a positive connection which preferably creates a connection between a cover element and at least one cell compartment element without any other components.

A connecting area in the sense of the invention refers to a specific section of a cell compartment element. A first cell compartment element particularly contacts a second cell compartment element in this connecting area.

In accordance with the invention, a tempering medium refers to a gaseous or liquid fluid. The tempering medium is particularly provided for the purpose of conveying a flow of energy to or from the battery housing.

Flow channels in the sense of the invention refer to hollow spaces in the battery housing. Tempering medium methodically flows through the hollow spaces and can thus be present in both one or a plurality of cover elements and in one or a plurality of cell compartment elements.

The cell compartment elements are particularly produced from a metallic material or preferably from a fiber composite material. Said material in particular has high thermal conductivity, preferably thermal conductivity of λ_{20°} at 20° C. 40 to 1000 W/(K*m), preferably 100 to 400 W/(K*m) and particularly preferred at approximately 220 W/(K*m). The material preferably comprises aluminum as a substantial component, further components can in particular be manganese, magnesium, copper, silicon, nickel, zinc and beryllium.

Thermal conductivity in a fiber composite material is achieved in particular by a high percentage of thermally conductive fibers particularly consisting of a material having the above-cited thermal conduction properties, in particular, a fiber composite material has a fiber content of 30-95% by volume, preferably 40-80% by volume and particularly preferred of 50-65% by volume.

The cell compartment elements are particularly produced from a hybrid material. A hybrid material in the sense of the invention refers to a material consisting of some areas of plastic, particularly a fiber-reinforced plastic, and some areas of a metallic material. The areas of metal hybrid material have particularly good thermal conduction properties; the areas of fiber-reinforced plastic have particularly good thermal insulation properties. Said thermal insulation is particularly characterized by a thermal conductivity of less than 0.5 W/(K*m), preferably less than 0.2 W/(K*m) and particularly preferably less than 0.1 W/(K*m) at 20° C. in each case.

The favorable thermal conduction properties and in the case of a hybrid material, also the good insulation properties of the battery housing, allows an influencing of the temperature balance of the energy storage cells. In particular, heat is released to the environment surrounding the battery housing but at the same time uncontrolled heat is prevented from being transmitted from one cell compartment to another, thus increasing the operational

The cell compartment elements are particularly to be understood as being manufactured as thin-walled, shaped components. Such a shaped component preferably consists of a machined metal sheet produced in a shaping process such as folding, deep drawing, pressing or stamping, for example. Said sheet particularly has a well thickness of 0.3 mm-2.2 mm, preferably 0.8 mm-1.2 mm, preferably 1.0 mm. Appropriately selecting the wall thickness particularly yields a favorable weight-to-rigidity ratio (lightweight construction) for the battery housing, thus keeping external loads away from the electrochemical energy storage cells and thereby increasing operational reliability.

The cell compartment elements are particularly to be understood as being manufactured as thin-walled, shaped components. Primary shaping processes are in particular continuous casting or extrusion. A cell compartment element produced in such a primary shaping process preferably has a wall thickness, at least in parts, of 1.0 mm-3.0 mm, preferably 1.8 mm-2.5 mm and particularly preferred at 2.2 mm. The appropriate shaping and material selection particularly improves the temperature conduction of the cell compartment elements and thereby increases the operational reliability of the electrochemical energy storage cells.

Cell compartment elements of a metallic material are particularly provided with a thermal is insulating layer such as e.g. Mikrotherm in the contact areas with other cell compartment elements. Said thermal insulating layer is in particular vapor deposited or lacquered. The thermal insulating layer is particularly of a bright color, preferably white, particularly preferred is for the thermal insulating layer to be specular or reflective. This thereby in particular hinders thermal conduction from one cell compartment element to another and thus increases operational reliability.

The cell compartment elements are preferably to be understood as thin-walled shaped components produced from a hybrid material. A cell compartment element is thereby preferably positioned where it will contact a further cell compartment element made of plastic. In other areas, said cell compartment element is configured in particular from a metal material, This design to the cell compartment elements preferably hinders thermal transfer from one cell compartment to another and thus the reciprocal heating of the electrochemical energy storage cells and, on the other hand, fosters the dissipation of heat to the environment surrounding the battery housing. Preferably, the plastic area of the cell compartment element is at least partly coated with a thermally conductive layer, e.g. a heat conducting film, particularly in the area facing the electrochemical energy storage cells. This plastic area is preferably vaporized with a heat-reflecting layer. Said heat-reflecting layer is in particular white or specular. Said thermally conductive layer in particular exhibits a temperature-conducting connection with the metallic area of the cell compartment element.

The heat-reflecting layer particularly conducts a temperature flow from the electrochemical energy storage cells, conducting it to the metallic area of the cell compartment element. The appropriate shaping and material selection improves the temperature conductance of the cell compartment elements and thereby increases the operational reliability of the electrochemical energy storage cells.

A cell compartment element preferably comprises a connecting area provided to create a positive connection with a cover element. Such a positive connection preferably exists between a cover element and a plurality of cell compartment elements, preferably between one cover element and all of the cell compartment elements. The type of connection selected between the cover element and the cell compartment elements protects the contents of the cell compartment from external, particularly mechanical, influences and thus increases operational reliability.

An additional connecting element is preferably provided to create the positive connection. Such a connecting element is preferably a substantially elongated component. Said connecting element is preferably materially bonded, preferably at least sectionally bonded, to the battery housing. A materially bonded connection is thus preferably created between the connecting element, the cover element and/or the cell compartment element. The particularly stress-resistant design to the connecting area increases operational reliability.

The positive connection between a cover element and a cell compartment element is preferably created without additional connecting elements. Such a snap-lock connection preferably connects a cover element to one or preferably all cell compartment elements. Such a snap-lock connection is preferably a force-fit, or particularly preferred a form-fit, connection. The particularly simple design of the cover element connecting area has just few potential sources for errors during assembly or manufacture, thus increasing operational reliability,

Preferably, two neighboring cell compartment elements have a common connecting area. Said cell compartment elements are preferably in contact in said connecting area. The cell compartment elements are preferably materially bonded together in said connecting area. Such a materially bonded connection is preferably created by bonding. The cell compartment elements are preferably positively connected together in said connecting area. Additional fins, representing such a connecting area for the battery housing, provides a particularly rigid and thus secure battery housing.

A tempering medium is preferably provided in a battery housing. Said tempering medium is preferably provided to conduct a flow of energy. This energy flow is preferably conducted to or from a cover element. Conducting said flow of energy to or from at least one cell compartment element is particularly preferred. The tempering medium preferably flows through at least one cell compartment element and at least one cover element. A plurality of battery housings can preferably be connected by means of tempering medium connections. To be understood as a tempering medium connection is an element through which the tempering medium can enter or exit the battery housing. The tempering medium can easily pass though a plurality of battery housings by means of connecting the plurality of tempering medium connections. Actively controlling the temperature of the electrochemical energy storage cells increases the operational reliability of same. One tempering medium connection is preferably configured as a quick connector.

A cell compartment element preferably comprises one or preferably a plurality of through-flow channels. Two cell compartment elements preferably form at least one through-flow channel. Said through-flow channels are provided to enable the flow of tempering medium. Such through-flow channels are preferably evacuated between two cell compartment elements with no medium flowing through them. The pressure in such a compartment thereby preferably amounts to 0.9*10⁵ Pascal to almost 0 Pascal. preferably 0.8*10⁵ Pascal to 0.5*10⁵ Pascal, and particularly preferred at 0.7*10⁵ Pascal to 0.6*10⁵ Pascal. Evacuating the through-flow channels lowers the thermal conductivity of these areas to preferably less than 0.03 W/(m*K) at 20° C.

Said through-flow channels are preferably filled with a phase change material (PCM) which is solid at ambient temperature, e.g. a salt or a paraffin. Upon the temperature within the through-flow channels rising preferably higher than 200° C. or particularly preferably higher than 100° C., said phase change material changes from its aggregate state and liquefies. The liquefaction preferably absorbs thermal energy. Less thermal energy passes from one cell compartment to the other as a result of this aggregate state change, thereby increasing the operational reliability of the electrochemical energy storage cells.

Preferably, one, two or more through-flow channels of one battery housing can each be connected to a respective through-flow channel of a further battery housing. This connection of through-flow channels of multiple battery housings preferably creates a common tempering medium circuit. Said through-flow channels are preferably connected together by means of tempering medium connections; the tempering medium connections are preferably configured as connector pieces. A connector piece is preferably connected to at least one cover element or to at least one cell compartment element in fluid-tight manner, preferably by means of flexible sealing means or particularly preferred by means of a materially bonded connection. The flexible sealing means is preferably fit in a recess of the connector piece or the battery housing. A flexible sealing means is preferably a flexible ring such as an O-ring. Preferably, the cross-sectional shape of a connector piece largely corresponds to the cross-sectional shape of the through-flow channels in the area of the through-flow channels to be connected. The cross section of a connector piece is preferably configured such that same projects at least partially into a through-flow channel, Preferably, at least one through-flow channel exhibits a connecting projection. Said connecting projection preferably projects at least partly into a connector piece or through-flow channel and is connected to same in fluid-tight manner. The fluid-tight connecting of through-flow channels increases the operational reliability of the battery housing.

A battery housing preferably comprises an electrical system interface. Such an electrical system interface preferably exhibits two coordinated system interface components each having preferably 2 to 7, preferably 5, electrical contacts. Such an electrical system interface on a battery housing is preferably configured as one part of a two-part connection assembly. Such a connection assembly preferably comprises at least one male and one female part. A battery housing preferably comprises one female or one male part, or preferably one female and one male part, of said connection assembly, particularly preferred a plug and a socket or female connector respectively. Such a female and male part are preferably mounted on opposite sides of the battery housing. The electrical system interface simplifies the joining of individual battery housings into one assembly and thus increases operational reliability.

To manufacture a battery housing, cell compartment elements are preferably produced in an appropriate primary shaping/shaping manufacturing process. Said cell compartment elements are preferably brought into a predetermined position relative one another to produce the battery housing. Preferably, at least one of said cell compartment elements is then connected to at least one cover element. Contact points between the cover element and cell compartment elements, provided for a tempering medium to flow through, are preferably connected in fluid-tight manner. Such a connection is preferably created by means of flexible sealing means such as e.g. O-rings or sealing lips or by means of a materially bonded connection using sealing paste or sealing tape.

To manufacture a cell compartment element from a hybrid material, a metallic insert is preferably inserted into a mold and connected at its edge region to a cell compartment element In a plastic material bond. The insert is preferably configured with recesses in said edge region so as to form a solid connection particularly with the plastic area of the cell compartment element.

A cell compartment element is preferably connected o a cover element by means of material bonding, preferably by bonding or welding.

The accompanying drawings reveal further advantages and embodiments of the present invention.

Shown are:

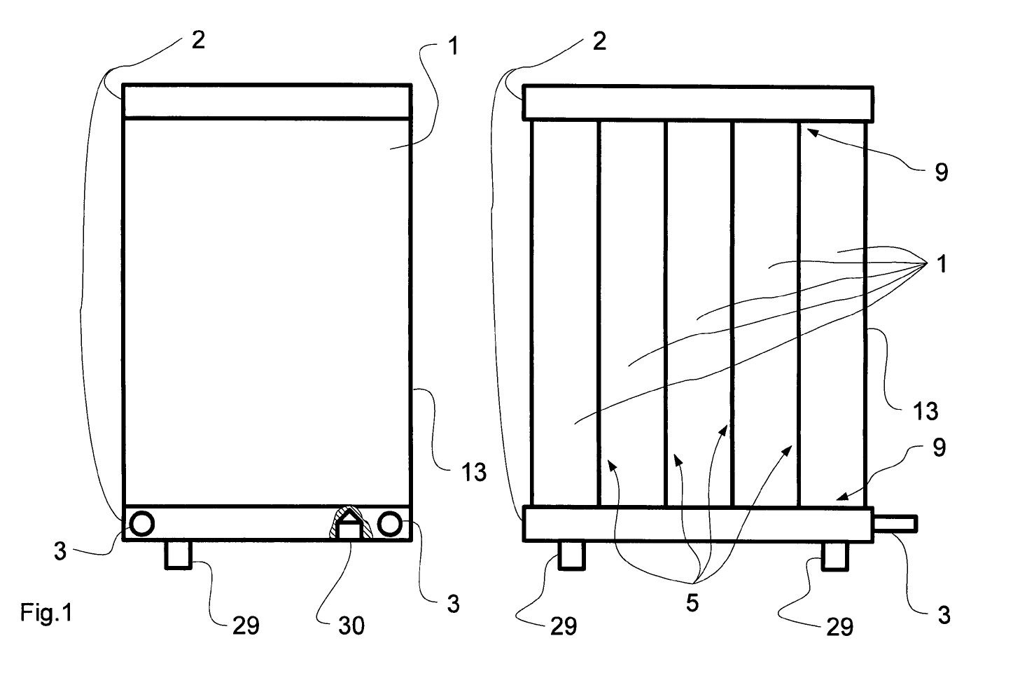

FIG. 1: a battery housing for electrochemical energy storage devices consisting of a plurality of cell compartment elements and two cover elements, wherein connections for a tempering medium are provided on a cover element,

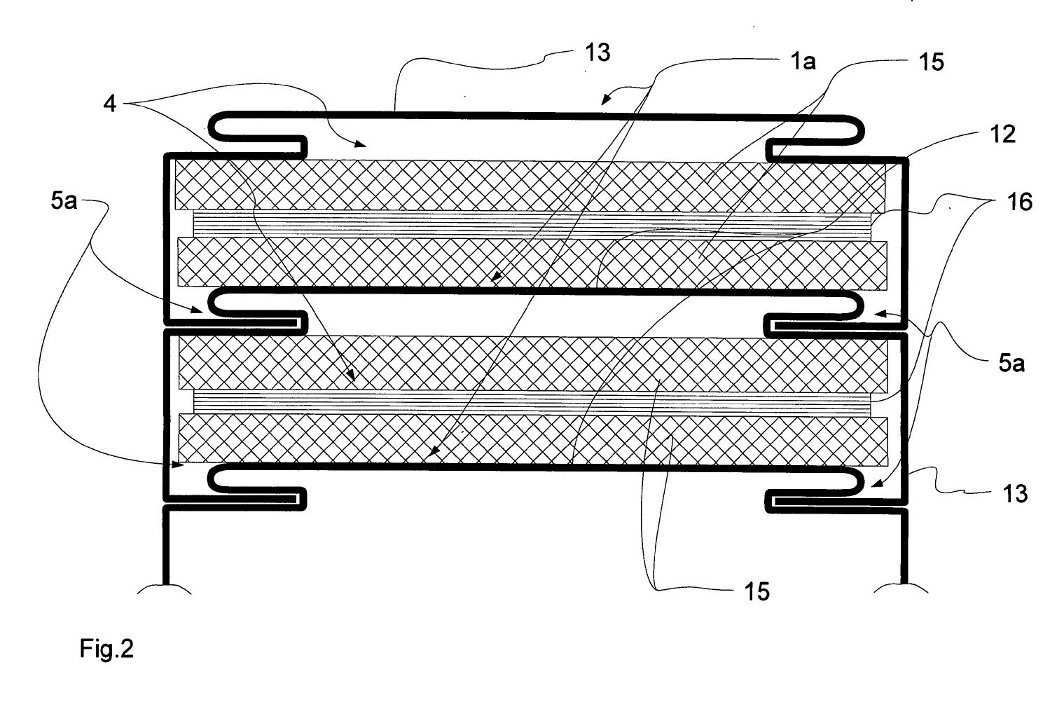

FIG. 2: two cell compartment elements with electrochemical energy storage cells. The cell compartment elements are hereby made from sheet metal and form a positive connection in their connecting area. A flexible compensating element is situated in the space between two electrochemical energy storage cells,

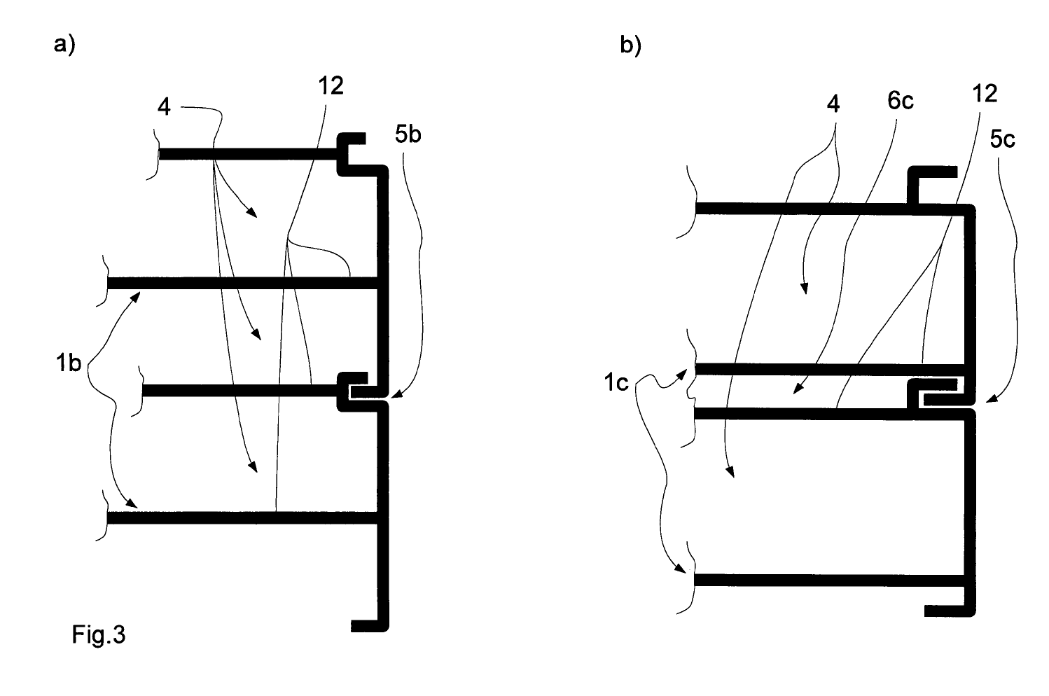

FIG. 3: two different designs of cell compartment elements realized as continuous cast profiles. In FIG. 3b, two cell compartment elements form a double wall through which tempering medium can flow.

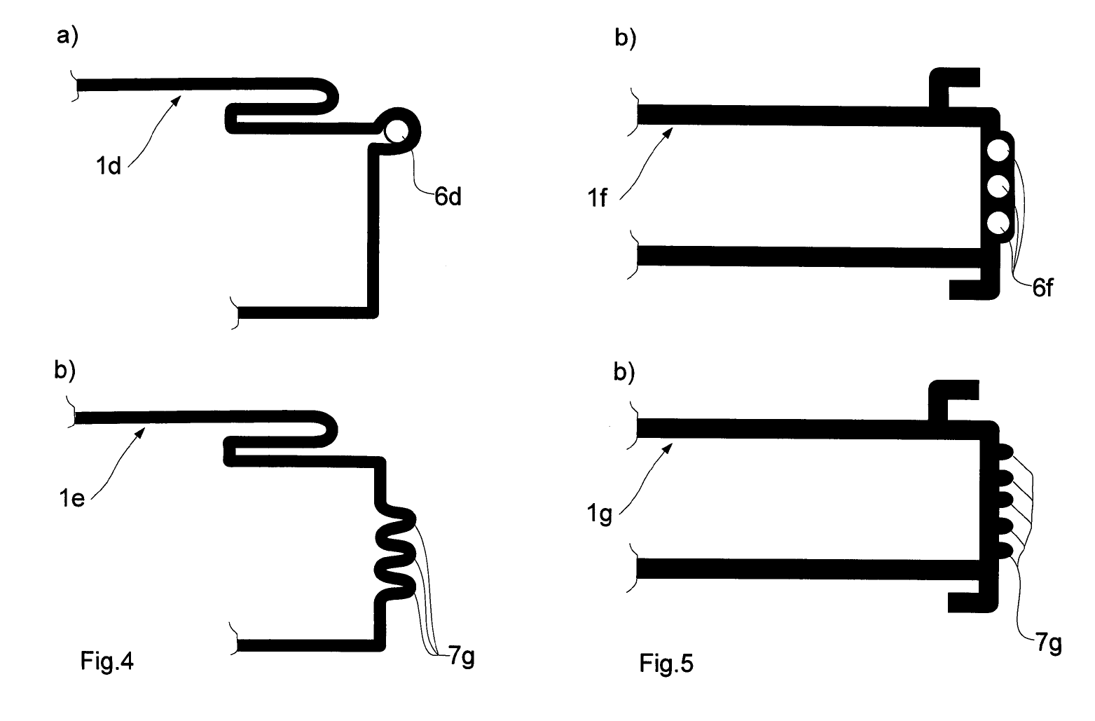

FIG. 4: two different designs of cell compartment elements made from sheet metal, wherein in FIG. 4a, a tempering medium line is introduced into the cell compartment element through which tempering medium can flow. FIG. 4b shows a cell compartment element having a plurality of cooling fins provided to enlarge the surface area of the cell compartment element and thereby improve thermal conduction,

FIG. 5: two different designs of cell compartment elements made of continuous cast profiles, wherein in FIG. 5a, through-flow channels through which a tempering medium can flow are incorporated into the cell compartment element. FIG. 5b shows a cell compartment element having a plurality of cooling fins provided to enlarge the surface area of the cell compartment element and thereby improve thermal conduction,

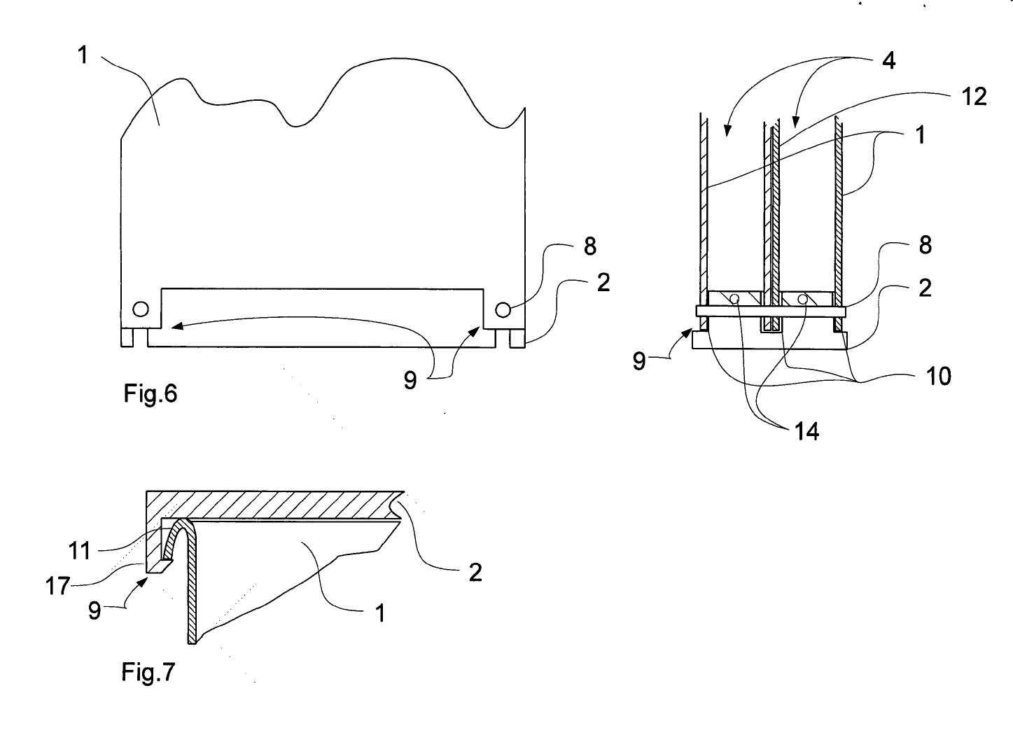

FIG. 6: the connecting area between cell compartment elements and a cover element, wherein the connection is created by a connecting element. Said connecting element is bonded to the cover element and the cell compartment elements,

FIG. 7: the connecting area between cell compartment elements and a cover element, wherein the connection is created by means of a snap-lock connection,

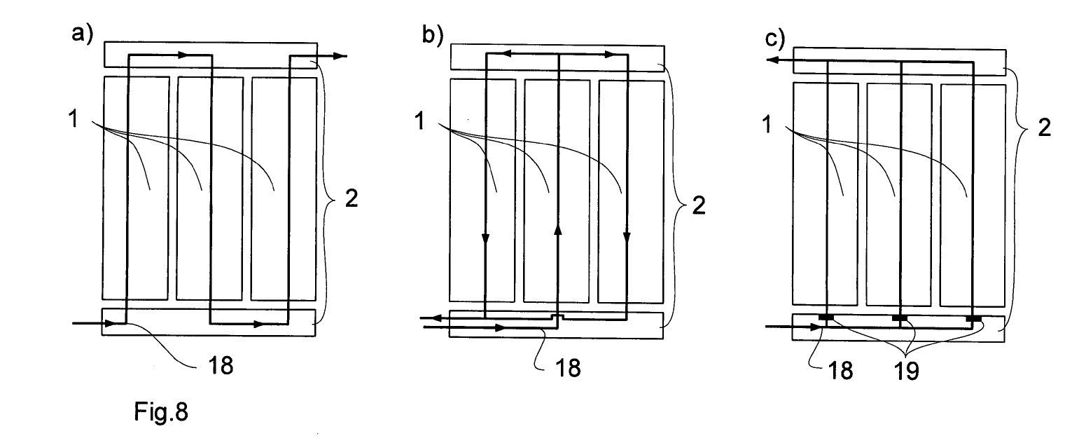

FIG. 8: various options for flows through cell compartment elements, wherein the cover element regulates the tempering medium flow,

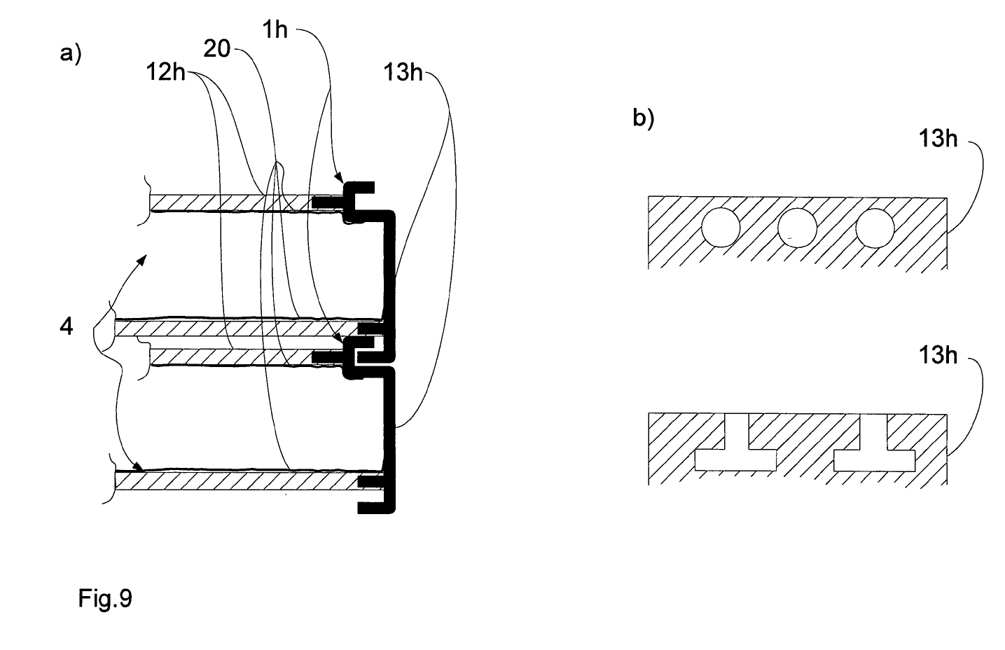

FIG. 9: a cell compartment element made from a hybrid material,

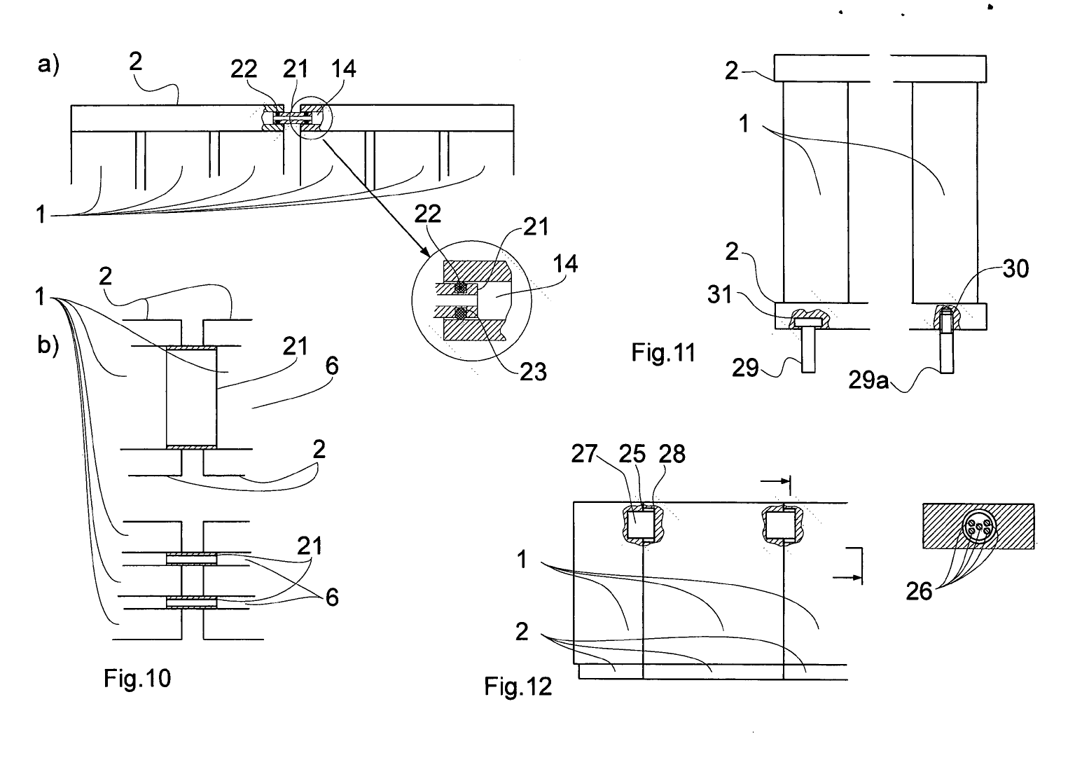

FIG. 10: two different types of through-flow channel connections. FIG. 10a) shows a through-flow channel connection sealed with flexible sealing means. FIG. 10b) shows two through-flow channel connections sealed with materially bonded sealing means,

FIG. 11: two different types of securing bolts wherein one securing bolt is materially bonded and a further securing bolt is positively connected to the cover element, and

FIG. 12: a plurality of battery housings with their electrical connection to a plug and socket connection having five electrical system contacts.

Reference will first be made to FIG. 1 in describing the invention by way of example.

FIG. 1 depicts a battery housing for accommodating electrochemical energy storage cells 15. Said battery housing comprises two cover elements 2 and a plurality of cell compartment elements 1, Two connections 3 for a tempering medium are thereby incorporated in a cover element 2. The tempering medium flows into the cover element 2 through said connections.

The tempering medium flows back out of the cover element 2 to the second connection 3 through the individual cell compartment elements 1.

FIG. 2 depicts two cell compartment elements 1a made of sheet metal, Said cell compartment elements 1a together form a connecting area 5a. The two cell compartment elements 1a are connected together by material bond in said connecting area 5a. The cell compartments 4 are separated from each other by a partition wall 13, Two electrochemical energy storage cells 15 are situated within each cell compartment 4. Said energy storage cells 15 are pressed against cell compartment element 1 by flexible compensating elements 16 which thereby creates a temperature-conducting connection between the cell compartment element 1 and the energy storage cell 15.

FIG. 3a depicts two cell compartment elements 1b made of a continuous cast profile. Said two cell compartment elements 1b together form a common connecting area 5b. The cell compartment elements 1b are positively connected together in said connecting area 1b.

FIG. 3b shows two cell compartment elements 1c made of a continuous cast profile. Said two cell compartment elements 1c together form a common connecting area 5c. The connection of the two cell compartment elements 1c creates a double wall hollow space 6c between them. Said hollow space 6c is provided for the flow of a tempering medium. The two cell compartment elements 1c are connected together in connecting area 5c in fluid-tight manner. Suitably selecting the wall thickness in the area of the double partition wall 12 yields a flexible area for the cell compartment element 4. Said flexible area of cell compartment element 1c does away with the need for the flexible compensating element 16 between the energy storage cells 15.

FIG. 4a depicts a cell compartment element 1d made from sheet metal. The cell compartment element 1d exhibits a shape allowing for a tempering medium line 6d to be incorporated into said cell compartment element 1d. The tempering medium line 6d is provided for the flow of a tempering medium.

FIG. 4b depicts a cell compartment element 1e made from sheet metal. Said cell compartment element 1e comprises a plurality of cooling fins 7e. Said cooling fins 7e enlarge the surface area of the cell compartment element 1e, thus achieving better temperature conductance.

FIG. 5a depicts a cell compartment element 1f made of a continuous cast profile. Through-flow channels 6f are incorporated into said cell compartment element 1f. These recesses 6f are provided for the flow of a tempering medium. Said through-flow channels 6f can also be situated in the partition walls 12. The through-flow channels 6f in the cell compartment elements 1f can also be connected to the cover through-flow channels 14 (not shown).

FIG. 5b depicts a cell compartment element 1g made of a continuous cast profile. Said cell compartment element 1g comprises a plurality of cooling fins 7g provided to enlarge the surface area of the cell compartment element 1g. Enlarging the surface area achieves better temperature conductance. Said cooling fins 7g are thereby advantageously aligned so as to allow a flow of air, either generated artificially or by heating the ambient air, in the longitudinal direction of said fins.

FIG. 6 depicts the connecting area 9 between a cover element 2 and cell compartment elements 1. The cover element 2 exhibits a series of cell compartment recesses 10 Cell compartment elements 1 engage in said recesses 10. The cell compartment elements 1 and the cover element 2 are materially bonded together by means of a connecting element 8. Said connecting element 8 is connected to the cell compartment elements 1 and the cover element 2 by material bonding. Alternatively, the connecting element 8 can be connected to the cover element 2 or the cell compartment elements 1 using fixing means such as e.g. screws, rivets or pins.

FIG. 7 depicts the connecting area 9 between a cover element 2 and the cell compartment elements 1. A special design to the cell compartment elements is provided to create this snap-lock connection. The cell compartment elements comprise a flexibly deformable snap-fit area 11. The cover element 2 comprises a notched section 17 in which the snap-fit area 11 of the cell compartments 1 can snap into place. The snap-lock connection can also be created by means of additional spring or auxiliary elements.

FIG. 8 depicts various options for flows through cell compartment elements.

FIG. 8a shows a serial flow through three cell compartment elements. The tempering medium flow 18 enters into a cover element 2 and is conducted from same to an outer cell compartment element 1. From there, the tempering medium flows outward through one cell compartment element 1 after the other. The tempering medium flow 18 exits again through a second cover element 2.

FIG. 8b shows another embodiment for flows through a plurality of cell compartment elements 1, In this embodiment, the tempering medium flow is first conducted though cover element 2 to a cell compartment element 1, same being at least partially surrounded by other cell compartment elements 1. From this cell compartment element 1 being the first through which the flow passes, the tempering medium flow 18 portions into a second cover element 2 and then simultaneously flows (in parallel) though two further cell compartment elements 1. The tempering medium flow 18 exits from the same cover element 2 into which it previously entered.

FIG. 8c shows a further embodiment for flows through a plurality of cell compartment elements 1. Here, the cover element 2 comprises tempering medium valves 19. Said tempering medium valves 19 allows the selective conducting of the tempering medium flow 18 to individual cell compartment elements 1. Preferably, not all of the cell compartment elements 1 need to be regulated by their own tempering medium valve 19, Said tempering medium valves are preferably thermostats. Such thermostats release or cut off the tempering medium flow 18 to the cell compartment elements 1 or restrict the flow rate. Such thermostats operate as a function of the temperature of, for example, the tempering medium flow 18.

FIG. 9 depicts an embodiment of a cell compartment element 1h made from a hybrid material. Thermal conduction from one cell compartment element to the next is hindered by the plastic thermally-insulating partition wall 12h (FIG. 9a). However, a metallic side wall 13h fosters thermal conduction from one cell compartment element 1h to the environment surrounding the cell compartment element. The side wall 13h is connected to the heat-conducting film 20 in temperature-conducting manner. The heat-conducting film 20 conducts a thermal flow away from the surface of the electrochemical energy storage cell and releases it at side wall 13h, Doing so thus effectively prevents the reciprocal heating of the electrochemical energy storage cells in neighboring cell compartments. FIG. 9b depicts various options for the design of the edge area of side wall 13h. The recesses provided in side wall 13h result in a better connection of the metallic side wall 13h to the plastic partition wall 12h.

FIG. 10 shows the connection of cover through-flow channels 14.

FIG. 10a depicts the connection of two cover through-flow channels employing a connector piece 21 and a flexible sealing means 23. The flexible sealing means 23 is accommodated in a recess 22 of the connector piece 21 and contacts said connector piece 21 and the cover element 2. Hence, a fluid-tight connection is created between the connector piece 21 and the cover elements 2.

FIG. 10b depicts the connection of through-flow channels 6 employing connector pieces 21. The through-flow channels 6 are formed substantially through the cell compartment elements 1. The connector pieces 21 are materially bonded to the through-flow channels 6. The material bond creates a fluid-tight connection between the through-flow channels 6 and the connector pieces 21.

FIG. 11 shows battery housings comprising securing bolts 29, 29a. A securing bolt 29 is connected to the cover element 2 by means of a material bond connection 31. On its end connected to the cover element 2, the securing bolt 29 exhibits a cross-sectional modification. This cross-sectional modification achieves a particularly solid material bond connection 31 between the securing bolt 29 and the battery housing. In a further embodiment, the securing bolt 29a is connected to the cover element 2 by means of a positive connection 30. The securing bolt 29a is screwed into the cover element 2 and can thus be non-destructively disjoined from the cover element as needed.

FIG. 12 shows the electrical connection of a plurality of battery housings. Said electrical connection is realized by the electrical system interface 25. The electrical system interface 25 comprises a two-piece plug and socket connection consisting of a male part, plug 27, and a female part, socket 28. Five system contacts 26 are provided in the plug 27 and in the socket 28. Said system contacts 26 allow information on battery status, control commands and electrical output to be exchanged between the battery housing and a battery control.

1-15. (canceled)

16. A battery housing, comprising:
a cell compartment element at least partially delimiting a cell compartment for accommodating at least, one electro-chemical energy storage cell; and
a cover element, connected to said cell compartment element, including a hollow space, a tempering medium being selectively fluidly conducted at least one of to and from the cell compartment element through the hollow space.

17. The battery housing according to claim 16, further
at least one additional cell compartment element, the cover element also being connected to the at least one additional cell compartment; and
at least one additional hollow space in the cover element for conducting the tempering medium;
wherein the tempering medium flows through at least one of the hollow space and the additional hollow space.

18. The battery housing according to claim 17, wherein:
the tempering medium flows through the hollow space and the additional hollow space in any order.

19. The battery housing according to claim 17, wherein:
the tempering medium flows through a plurality of the cell compartment elements in parallel,

20. The battery housing according to claim 16, further including:
a mechanism incorporated into the over element for actively conducting the tempering medium flow.

21. The battery housing according to claim 17, wherein:
the hollow spaces of the cover element open and close as a function of at least one of external control commands and a temperature of the tempering medium.

22. The battery housing according to claim 16, further including:
a valve for selectively conducting the flow of the tempering medium,

23. The battery housing according to claim 22, wherein:
the valve includes a thermostat that selectively conducts the flow of the tempering medium as a function of temperature.

24. The battery housing according to claim 22 wherein:
the valve is included in the cover element,

25. The battery housing according to claim 16, wherein:
the cell compartment element includes a through-flow channels for the flow of the tempering medium.

26. The battery housing according to claim 25, further including:
at least one additional cell compartment element;
wherein the flow-through channel is formed by the cell compartment element and one of the additional cell compartment elements.

27. A battery, comprising:
a plurality of electrochemical energy storage cells; and
a battery housing, including:
a cell compartment element at least partially delimiting cell compartments, the cell compartments accommodating respective ones of the electro-chemical energy storage cells: and
a cover element, connected to said cell compartment element, including a hollow space, a tempering medium selectively flowing through the hollow space.

28. A method of manufacturing a battery housing including a cell compartment element at least partially delimiting a cell compartment for accommodating at least one electro-chemical energy storage cell, and a cover element, connected to said cell compartment element, including a hollow space, a tempering medium selectively flowing through the hollow space, the method comprising:
defining a plurality of the cell compartment elements into respective predefined positions relative one another; and
connecting at least one of the cell compartment elements to the cover element.

29. The method of manufacturing a battery housing according to claim 28, wherein the connecting step includes:
bonding the at least one cell compartment element to the cover element

30. The battery housing according to claim 28, further including:
connecting the at least one cell compartment element to the cover element for forming a through-flow channel.

31. The battery housing according to claim 30, further including:
connecting the at least one cell compartment element to the cover element in a fluid-tight manner at least in an area of a through-flow channel.
